(19) United States
(12) Patent Application Publication
(10) Pub. No.: US 2008/0243890 A1
(43) Pub. Date: Oct. 2, 2008

(54) AUTOMATED TWO AND THREE DIMENSIONAL TECHNICAL DATA PACKAGING

(75) Inventors: John GLATFELTER, WEST CHESTER, PA (US); Larry M. COX, MADISON, AL (US); Gregory J. GILPIN, MORTON, PA (US)

Correspondence Address: BROSEMER, KOLEFAS & ASSOCIATES, LLC - (BOEING), 1 BETHANY ROAD, Suite 58, HAZLET, NJ, 07730, US

(73) Assignee: THE BOEING COMPANY, CHICAGO, IL (US)

(21) Appl. No.: 11/693,782

(22) Filed: Mar. 30, 2007

(51) Int. Cl. G06F 17/00

(52) U.S. Cl. 707/101; 707/E17.002

(57) ABSTRACT

Production of two and three dimensional technical data packages is automated by a computer that receives and stores one or more customer defined data submittal rules for formatting a technical data package. The computer then executes one or more of the rules to create a linked set of output data files comprising the technical data package. The computer creates a hierarchical product data tree structure comprising one or more nodes and one or more product attribute data fields for each node. The computer creates the technical data package file by linking parts files together in accordance with the product data tree structure. The technical data package created by the computer may be compressed and sent electronically to the customer avoiding the requirement of using cumbersome technology such as aperture cards.

### CROSS REFERENCE TO RELATED APPLICATION

This application is a continuation-in-part of application Ser. No. 11/536,787, filed Sep. 29, 2006, of John W. Glatfelter et al., entitled “Automated Two Dimensional Technical Data Packaging.

### FIELD OF THE INVENTION

This disclosure relates to data packaging, more particularly, automated data packaging.

### BACKGROUND

The problem to be solved is to improve the efficiency of delivering two dimensional (2D) technical drawing packages (2DTDP) and three dimensional (3D) technical drawing packages (3DTDP) to meet government requirements and specifications. Illustratively, TDPs can include two dimensional (2D) drawings, three dimensional (3D) geometric representations, parts lists, and associated customer and supplier specification documents.

In the past, technical drawing packages were delivered to government customers in the form of a deck of aperture cards which essentially are rectangular pieces of microfiche attached to a similarly shaped windows cut into a computer punch cards. Prior efforts required extensive labor and flow-time to collect and package data, to create and review aperture cards and then physically ship the deck to a government customer.

The problems with using aperture cards to deliver technical data include many time consuming process steps involving a great deal of manual labor, significant amount of rework involving a great of additional labor, and the necessity of blending together a large amount of disparate technical information created on potentially incomaptible systems. For example, elements that are unique to this problem include:

1. Complex Steps: the Existence of 11 Complex Manual Steps Which Includes:
a. Retreiving some or all of a bill of materials from a product data management computer system;
b. Retrieving and transcribing some or all of the bill of materials from the face of technical drawings that will make up a part of the deck of aperture cards;
c. Extracting and retrieving TIF images of the drawings from a CAD system and/or 3D representations of part geometry;
d. Retreiving vendor data from one or more databases or other sources;
e. Using conversion utilities to convert digital rasterized CAD drawings into 44″ overlapping frames files and/or using conversion utilities to convert 3D CAD geometry into neutral 3D formats.
f. Bundling up a request to an appropriate agency for aperture card creation;
g. Reviewing aperture cards that are created;
h. Submitting changes or corrections to the aperture cards upon review;
i. Formatting a government customer's bill of materials file in DoD format (unique for each site);
j. Creating a physical shipping package and mailing the 2D-TDP or 3D-TDP to the customer; and
k. Awaiting confirmation that the 2D-TDP or 3D TDP is acceptable.

2. Signficant Touch-Labor & Rework:
a. the investment of significant touch labor to retrieve and organize all of the components of the 2D-TDP or 3D-TDP;
b. the existance of a large amount of flow time required for each aperture card request to be processed;
c. the need to use multiple people and tools through the process;
d. the investment of time to create the aperture card request;
e. the delay of a large amount of time awaiting aperture card creation;
f. the investment of time to modify/edit corrections upon review;
g. conditionally, the investment of more time to remake unacceptable aperture cards; and
h. the investment of additonal time to ship and await delivery to the government customer.

3. Signficant Rework
a. Each time an engineering change occurs, the 11 steps (1a thru 1k) must be reprocessed to create a 2D-TDP or 3D-TDP; and
b. Each time an aperture card problem occurs, steps (1f thru 1k) must be reprocessed.

4. Unique CAD Formats
a. CADCAM tools and processes are preferred in producing technical data. For example the CATIA system from Dassault Systeme, the Unigraphics system from EDS, and several other systems are commonly used. These complex CAD systems, however, have their own unique translators and data formatting mechanisms that often are incompatible with one another.
b. CADCAM data typically is stored in different formats. Older CADCAM data is stored using older standards. As new standards emerge, these are not applied retroactively, but only for new data that is created. This creates unique data conversion challenges to deal with “recent intelligent CADCAM data” and “naive older CADCAM data”.

There are no known tools that can automate and computerize the creation of the technical data packages containing 2D or 3D data so as to avoid the 11 steps above. Typically, the 11 problems listed above are solved using high-volume low-cost labor to accomplish the tasks. Prior solutions are costly in terms of touch labor and flow-time and are only available for 2D data. The prior solutions for 2D data are also prone to rework because of the excessive touch labor and errors that are introduced into the process. Disadvantages include the need to work with disparate tools on different computer systems, provided by different suppliers and organizations to achieve a single 2D-TDP or 3D TDPs

### SUMMARY

The invention computerizes and automates a 2D & 3D Technical Data Process (A2&3DTDP). In one example of the invention, the process encapsulates all of the logic necessary to create 2D-TDP's or 3D-TDP's in a format that is consistent with the government customer's technical data package requirements as outlined, for example, in the Joint Engineering Document Management Information Control Systems (JEDMICS) specification document. The invention eliminates the need for aperture cards, reduces the 11 steps (steps 1a through 1k) by 80%, and automates the highly complex step of generating a site-specific bill of material file.

The A2&3DTDP has unique and novel features which include the following capabilities:
a. Provides a single method and apparatus in the form of a software toolbox that can be used to create 2DTDPs and 3DTDPs;
b. Eliminates the need for Aperture Cards by creating computer data files which are electronically transmitted to the government;
c. Provides a way to inspect the integrity of the 2DTDP or 3DTDP data prior to submittal to the government;
d. Is a desktop computer application that allows for push-button creation of the most complex steps, the importation/creation of a bill of materials, and the creation of the government site specific bill of materials file; and
e. Is flexible due to its ability to capture object-oriented rules that are CAD-independent (works with any computer aided design system) and PDM-independent (works with any product data management system).

The A2&3DTDP provides a significant reduction in flow-time when compared with the labor intensive (11 steps) aperture card process. There also is an additional significant reduction in flow time to process engineering changes.

The A2&3DTDP invention has been reduced to practice in the form of a software toolbox. It provides a menu option which links to other software such as a commercially available software product called ImagePrepPlus, from Tameran Corp. The purpose of this tool is to provide framing of large rasterized drawings into smaller 44″ overlapped files.

### BRIEF DESCRIPTION OF THE DRAWINGS

FIG. 1 is a high level block diagram of an automated 3D technical data packaging system in accordance with this invention.

FIG. 2 is a more detailed block diagram of the automated 3D technical data packaging processor of FIG. 1.

FIG. 3 is a detailed block diagram of the product data management interface of FIG. 2.

FIG. 3a illustrates a spread sheet containing product data obtained from a product data management system.

FIG. 4 is a detailed block diagram of the bill of materials import editor of FIG. 2.

FIG. 5 is a shot of the main screen of the system of FIG. 1 used to create a 3D technical data package.

FIG. 6 is a diagram of the tool bar from the screen shot of FIG. 5.

FIG. 7 is a diagram of additional control buttons on the screen of FIG. 5.

FIG. 8 is an example of an index file in a technical data package produced in accordance with this invention.

FIG. 9 is a detailed block diagram of the vendor information tables of FIG. 2.

FIG. 10 is an example of a spread sheet that contains supplier data.

FIG. 11 is a detailed block diagram of the 3D technical data package writer of FIG. 2.

FIG. 12 is detailed block diagram of the aircraft default rules module of FIG. 2.

FIG. 13 is a detailed block diagram of the user interface controller in FIG. 2.

### DETAILED DESCRIPTION

An automated two dimensional technical data packaging processor executes business and technical rules in order to create a linked set of output data files in accordance with customer data submittal requirements, such as those found in the various JEDMICS standards documents. Guided by a user-interface, a user accumulates a set of linked data files in a project directory. When complete, the user interface allows the user to automatically generate a two dimensional technical data package (2DTDP) or a three dimensional technical data package (3DTDP) and verify the data in the package is correct. If incorrect, an edit/change capability is supported and guided with color coded assistance. Upon completion, the 2DTDP or 3DTDP can be bundled in accordance with a final directory into a computer ZIP file for subsequent upload to customer sites, such as the Army's Aviation and Missile Command (AMCOM) website located at the Redstone Arsenal in Huntsville, Ala. Naval Air Systems (NAVAIR) in Lakehurst, N.J. retrieves their 2DTDP files from AMCOM's systems.

One key difference between the prior techniques of creating a technical data package and the technique described here is that, previously, physical aperture cards had to be created, checked, and shipped. With this technique, the data is electronic. This approach affords digital validation of the data and automation of the data creation. A second key difference is that, previously, the process of interacting with the disparate computing tools and processes were distributed over many organizations and computer systems. Now a single user can build the 2DTDP or 3DTDP file from his or her desk using the toolbox described below.

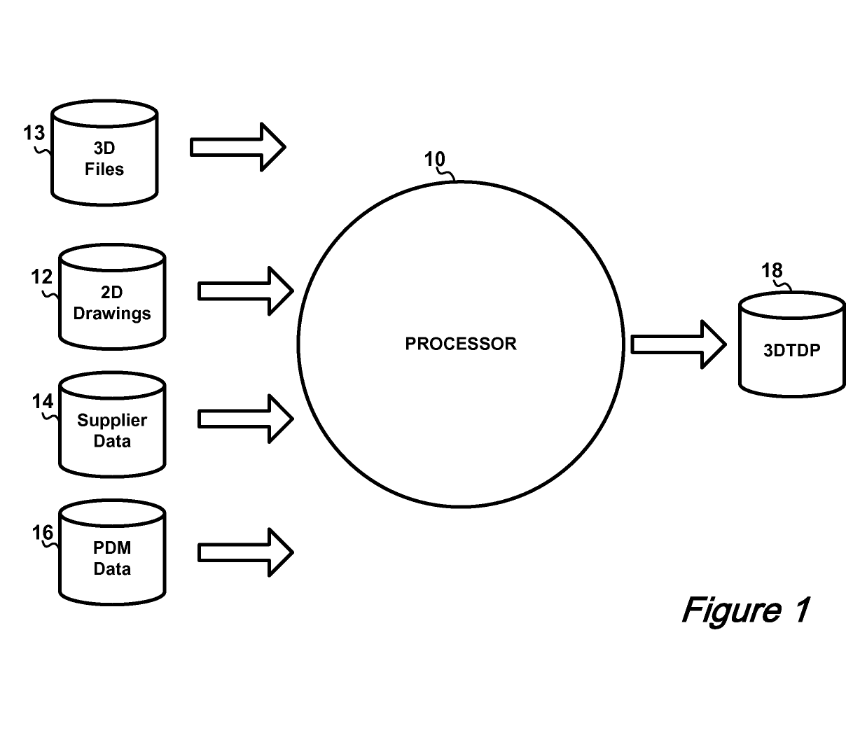

In accordance with one embodiment of the invention, FIG. 1 shows a computerized technical data packaging system in accordance with the invention. The computer system of FIG. 1 contains logic that is programmed to execute business and technical rules that are used to properly format a technical data package in accordance with customer requirements. In this example of the invention, a processor 10 operates on inputs consisting of two dimensional (2D) drawings stored in a database 12, 3D CAD files stored in a database 13, supplier data files stored in a database 14, and product data management (PDM) data stored in a database 16. The output of the processor 10 is one or more properly formatted 3D Technical Data Packages (3DTDP's) 18 which comply with customer submittal requirements. Those data packages 18 may include drawings, 3D part files, specifications, supplier or vendor information, and other information required by the customer submittal requirements.

In one example of the invention, the customer submittal requirements are specified in the Joint Engineering Document Management Information Control Systems (JEDMICS) Requirements Specification of the US military. In a more specific example of the invention, the customer submittal requirements are specified in the version of the JEDMICS specification in use at NAVAIR, Lakehurst, N.J., Rev M Oct. 17, 2002

The processor 10 may be any computer programmed in accordance with the principles outlined below. For example, the processor 10 may be an IBM compatible personal computer available from Dell computer or other similar sources. The processor 10 may also be a MacIntosh style personal computer available from Apple Computer. The processor 10 may also be a workstation available from companies such as Sun Microsystems.

The processor can be a standalone computer or a computer that is part of a computer network, such as a local area network or the Internet. The invention also is not limited to any particular way of supplying the input data to the processor 10. For example, the processor 10 may receive input data from one or more of data bases internal to the processor 10. The processor 10 may also received input data from external data bases directly connected to the processor 10 or connected to the processor 10 via one or more computer networks such as a local area network or a wide area network such as the Internet.

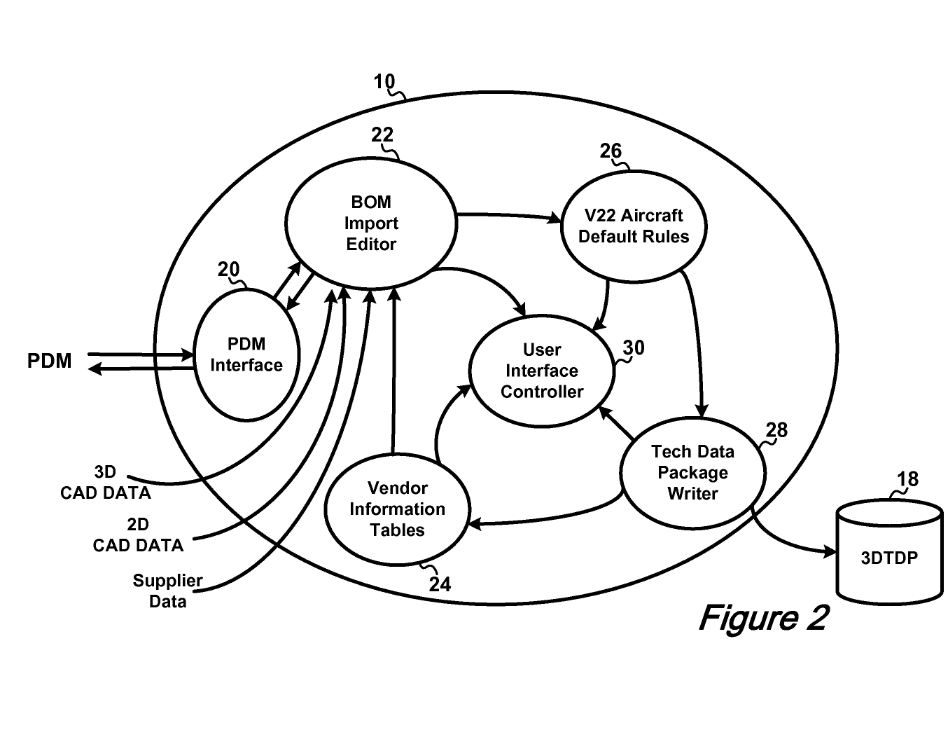

FIG. 2 is a detailed block diagram of the relevant soft ware modules in the processor 10 in FIG. 1. The software modules in FIG. 2 gather drawing, part, and specification files as well as product attribute data to create a set of linked files arranged in accordance with a hierarchical product tree. An index file, such as a data logistics file (DLF) specified in the JEDMICS standard, is also created and added to the linked files. This linked set of files and index file are assembled into single technical data package that may be sent electronically to a customer, thereby avoiding the complications of using aperture cards described above. In appropriate cases, the technical data package may be electronically compressed, for example, into a ZIP file, before being electronically sent to the customer.

As shown in FIG. 2, the processor 10 comprises a product data management (PDM) interface 20 connected to the PDM database 16. The PDM interface 20 receives the product data that will be configured into a hierarchical data tree that will define the organization of the technical data package 18. A bill of materials (BOM) import editor 22 receives data from the PDM interface 20, a vendor information table 24, and a default rules module that constructs and edits a product tree data structure composed of a series of hierarchically arranged nodes. Each node represents a name for an electronic file that contains technical data that goes into the technical data package 18. The electronic files may be 2D CAD drawings, 3D CAD files, specification sheets, manuals, parts lists, and other documentation containing information required for the technical data package 18. Associated with each node in the product data tree are one or more data fields that represent one or more product attributes that are required by the customer to be filled out by the supplier of technical data. For example, the US military requires anywhere from 53 to 94 product attributes to be provided in accordance with the JEDMICS specifications. Examples of typical product attribute data include part numbers, types, and names, drawing numbers, file names, code numbers, quantity, material type, next higher assembly (NHA), next lower assembly (NLA), and others.

A technical data package writer 28 assembles the data files that make up the 3DTDP 18 in accordance with the product data tree and creates an index file, such as a JEDMICS data logistics file (DLF) that is added to the 3DTDP 18. A user interface controller 30 monitors the status of the operations performed by the modules shown in FIG. 2 and notifies the user of the system.

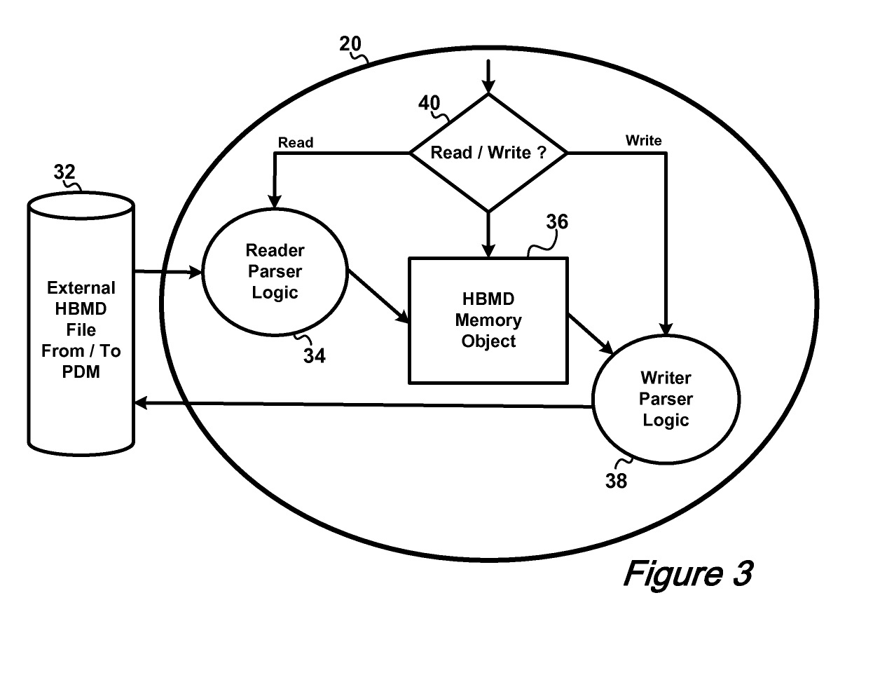

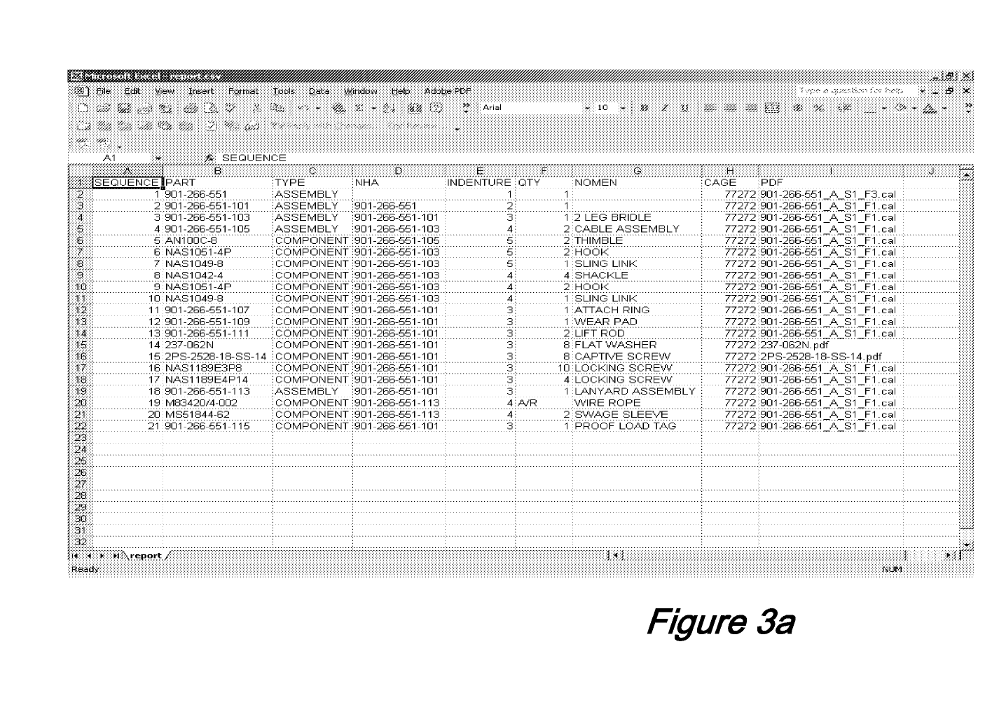

The details of the PDM interface 20 are shown in FIG. 3. The PDM interface 20 is a generic logic module which performs, at the driver level, the reading and writing of structured input, representing hierarchical bill of material data (HBMD). This HBMD may be stored in an Excel spread sheet stored on disk 32 in the processor 10. An example of such a spread sheet is shown in FIG. 3a. Data can be imported into 2DTDP or 3DTDP software from Excel using the provided template. This will allow for product data tree definition to begin the attribute assignment task needed for JEDMICS submittal.

The processor 10 uses the PDM interface 20 to cache external data into memory where it resides for processing by the other modules in the system. It consists of reader parser logic 34 which reads information received the PDM data base 16 and arranged on a spread sheet stored on disk 32. The reader parser logic 34 stores that information from the spread sheet in a user specified hierarchy in an HBMD memory object 36. Writer parser logic 38 retrieves the data from the HBMD memory object 36 and writes the data to permanent storage on disk 32. A decision block 40 is responsive to a read/write signal to select reading or writing operations in the PDM interface 20.

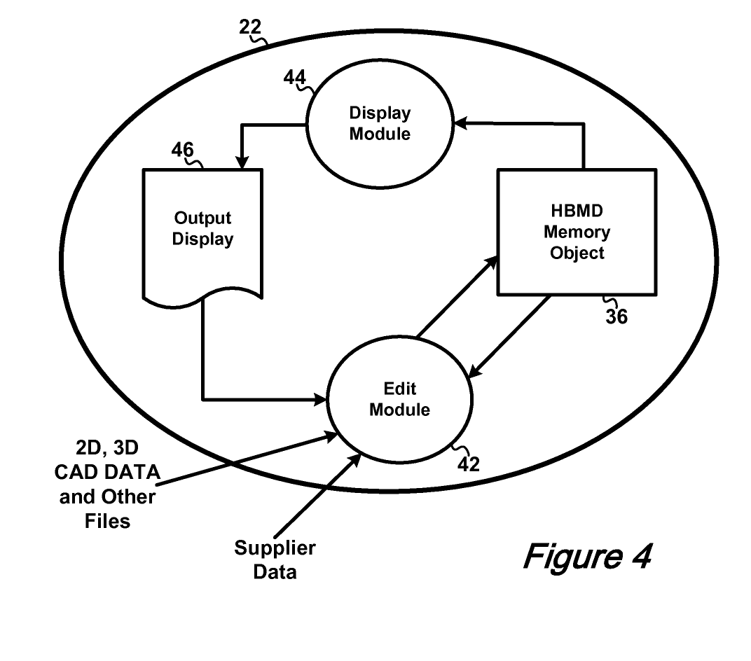

FIG. 4 is a detailed diagram of the BOM import editor 22. The BOM import editor 22 is a logic module which presents HBMD data in the memory object 36 to facilitate modification and editing of the product data tree. The BOM import editor 22 also links together the technical date files to which the product data tree points in accordance with the structure and hierarchy of the product data tree. The import editor 22 contains an edit module 42 that receives 2D CAD drawings, 3D CAD files, and other technical specification documents along with supplier data. The edit module 42 links the various files together in accordance with the product data tree stored in the HBMD memory object 36. The edit module 42 also allows editing of structure and hierarchy of the product data tree at all levels including both high level parent nodes, such as system and assembly level nodes, and at lower level child nodes such component and part nodes. Each node can contain up to 94 attribute fields and the BOM import editor 22 includes a display module 44 that facilitates observation of the product data tree on an output display 46 and editing of each of the nodes and the product attribute fields.

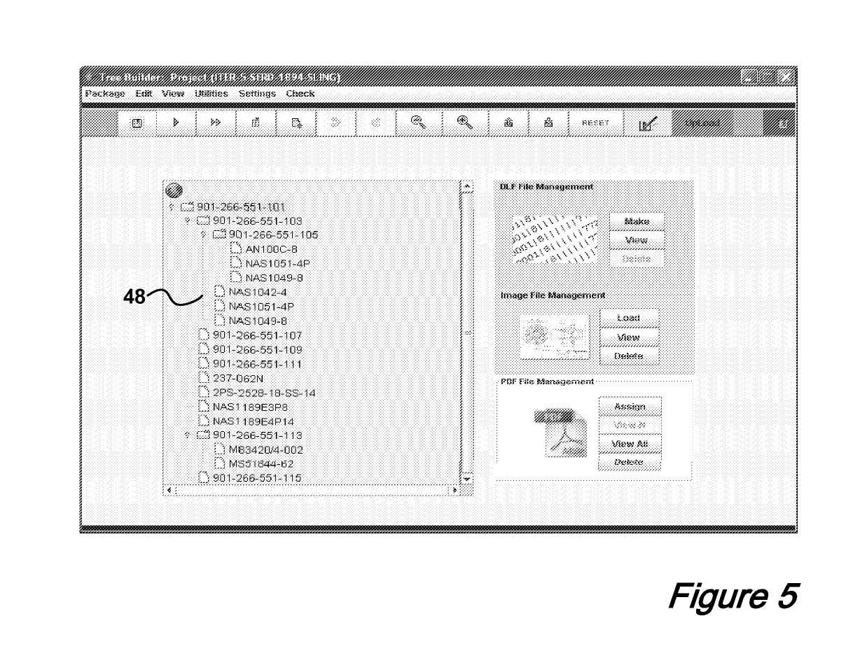

FIG. 5 is an illustrative screen produced by the BOM import editor 22 in the processor 10. Upon selecting a technical data package 18 to work on, BOM import editor 22 displays the screen in FIG. 5 which represents the main functional screen of the technical data packaging system. The user interacts with the input buttons on the right hand side of the screen of FIG. 5. The icons along the top of FIG. 5 are used to build a product data tree 48 which can be considered to be an indentured bill of materials.

As shown in FIG. 5, the editor 22 displays a representative hierarchical product data tree 48 composed of a list of file names of the documentation making up the 3DTDP 18. The file names are indented in the listing depending on their respective level in the hierarchy.

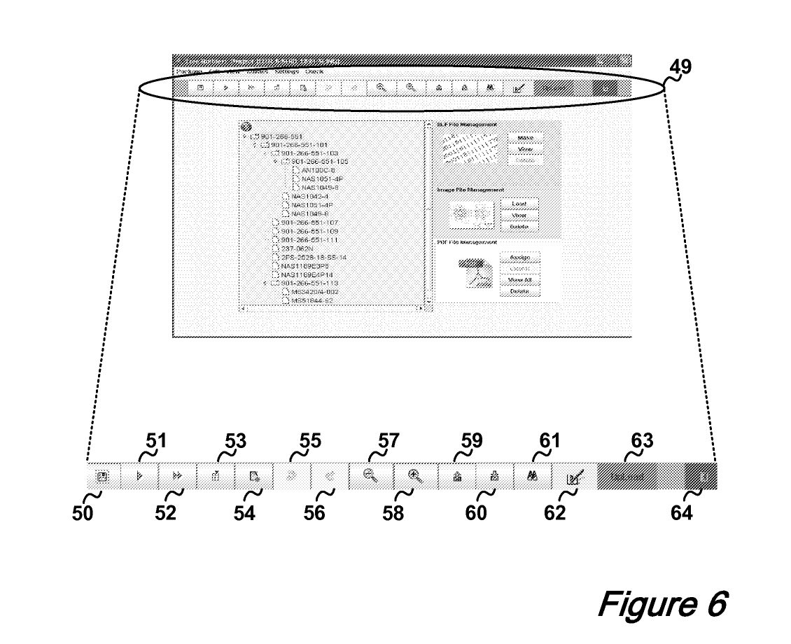

FIG. 6 is a diagram of the control elements provided by the BOM import editor 22. There are number of icons or buttons along the top horizontal tool bar 49 of the display of FIG. 5. They are used to manipulate and edit the 3DTDP 18 during the creation process. The functionality of the icons in the top horizontal tool bar is listed below:

| ICON | Description |
|---|---|
| 50 | save icon that allows for the technical data package to be stored |
| 51 | add icon that allows for a new product node to be added to a tree |
| 52 | rapid add icon that allows for automated product node adding |
| 53 | icon that enables attribute editing |
| 54 | icon that renames a node |
| 55, 56 | icons for undo and redo; respectively |
| 57, 58 | icons that allow for collapsing and expanding of the product |
| | Tree |
| 59 | icon that allows for a node to be move upward in an assembly |
| 60 | icon that allows for a node to be move downward in an assembly |
| 61 | icon that allows for a node to be searched |
| 62 | icon which invokes a data inspection process |
| 63 | icon which allows for electronic transmittal |
| 64 | icon which allows for deletion (or partial deletion) of a product |
| | assembly. |

The icons above are used to modify the content and the product data tree 48 of the evolving 3DTDP 18 prior to submittal. This indentured product data tree 48 represents the hierarchy of the product definition and forms the basis of the technical data package 18.

The icon/buttons to the right of the screen in the screen shot of FIG. 5 allow for linkages between the files making up the 3DTDP 18 to be created.

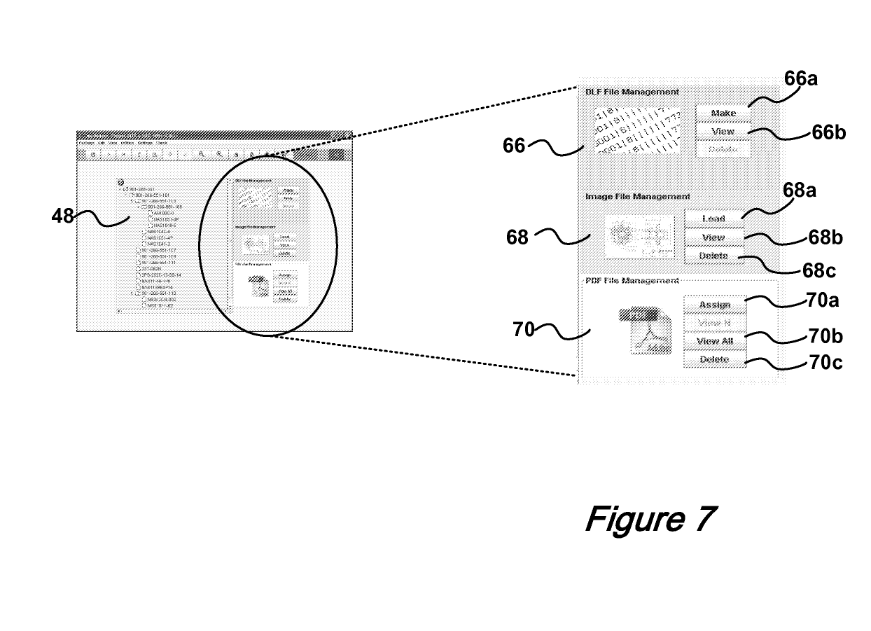

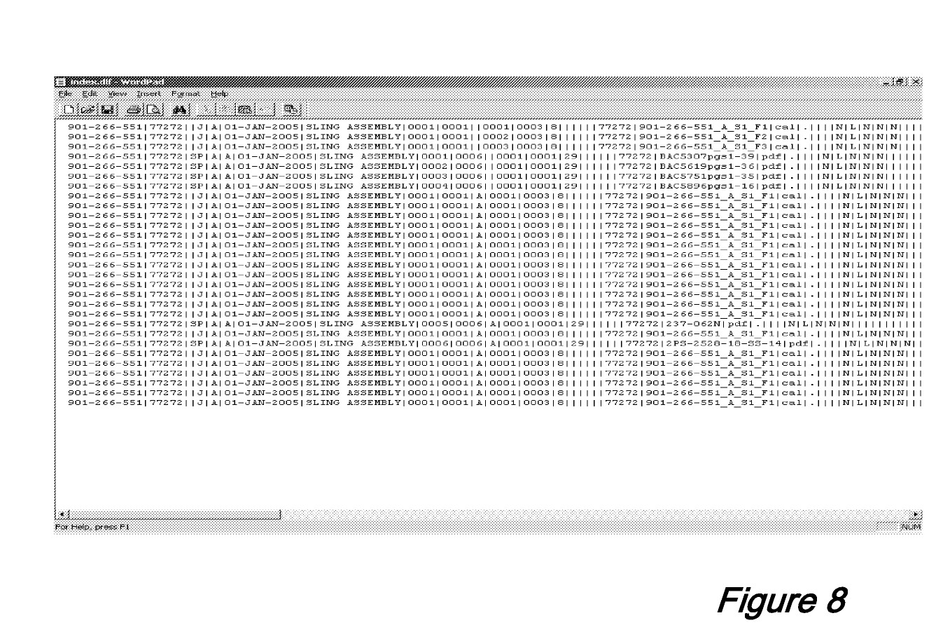

The DLF File Management buttons 66 shown in FIG. 7 provides two features. The make button 66a and view button 66b respectively allow for the creation and viewing of the Data Logistics File (DLF). An illustration of a DLF file is shown in the screen shot of FIG. 8. The output (DLF file) from the 3DTDP tool allows for uploading to a DoD server. The sample file above corresponds with the Drawing Data provided.

The Image File Management area 68 provides three buttons 68a, 68b, and 68c to manage the attachment and linkage of drawing files with their respective nodes in the product tree 48.

The PDF File Management area 70 has buttons 70a, 70b, and 70c that allow documents (such as vendor specifications and standards manuals) to be attached to their respective nodes in the product data tree 48.

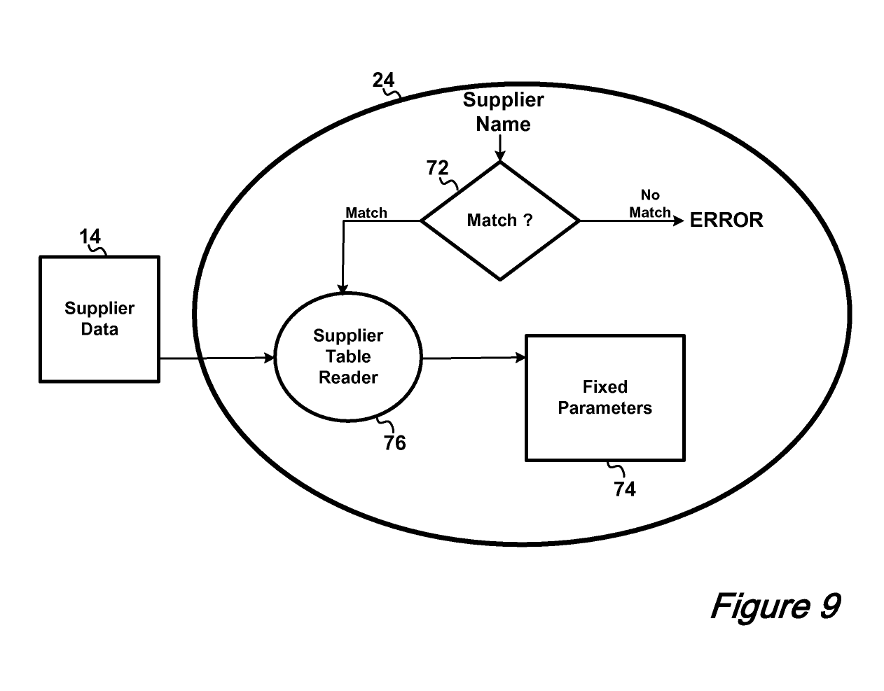

The details of the vendor information tables 24 in FIG. 2 are shown in FIG. 9. The vendor information tables are used to retrieve specific contact details (address, contact information, phone numbers, etc.) from the supplier database 14 for the exact components stored in the HBMD memory object 36. If there is a match in the supplier data, as determined by a decision block 72, a fixed parameters store 74 is updated by a supplier table reader 76. If not, an error is returned.

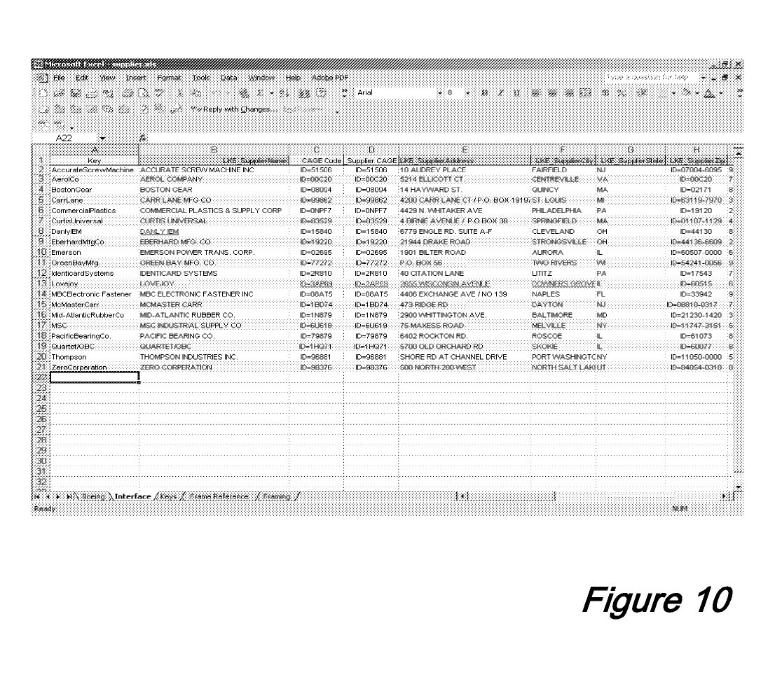

Supplier data is maintained in an Excel spreadsheet shown in FIG. 10 that is linked to the 3DTDP tool. This allows updates to existing suppliers and the addition of new suppliers as they arise, without impacting the code that drives the tool.

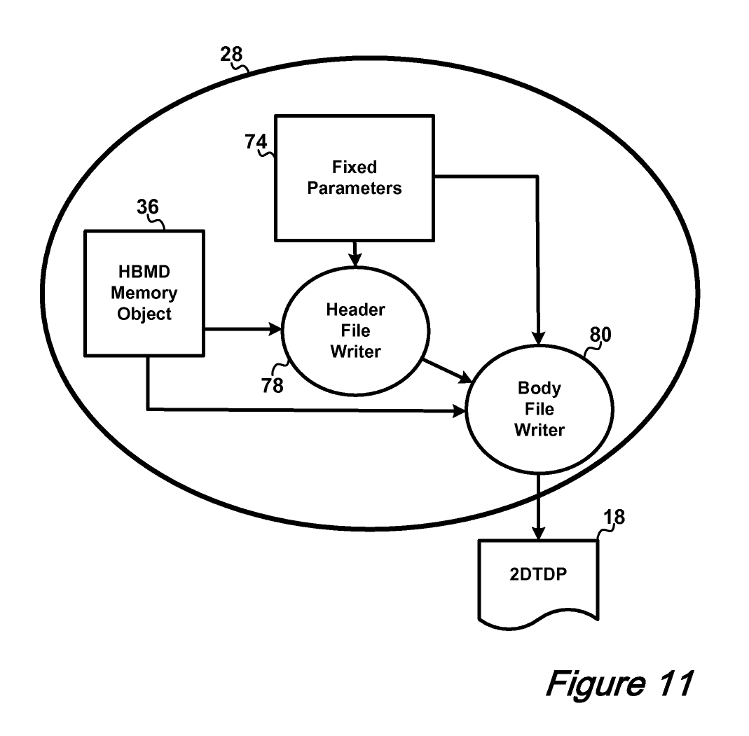

FIG. 11 shows the details of the technical data package writer module 28 in FIG. 2. The technical data package writer module 28 provides all of the logic necessary to create output 3DTDP's 18 compliant with customer submittal requirement, such as the JEDMICS specification document from NAVAIR Lakehurst. The 3DTDP's 18 include both header files and body files. Header files contain control information, such as file characteristics, that may be used by the receiver of the technical data to process the received files. The body files contain the actual technical data. Accordingly, the module 28 includes a header file writer 78 and a body file writer 80 that are responsive to the HBMD memory object 36 and the fixed parameters store 74 to copy header information and data files into a file folder organized in accordance with the product data tree 48 stored in HBMD memory object 36.

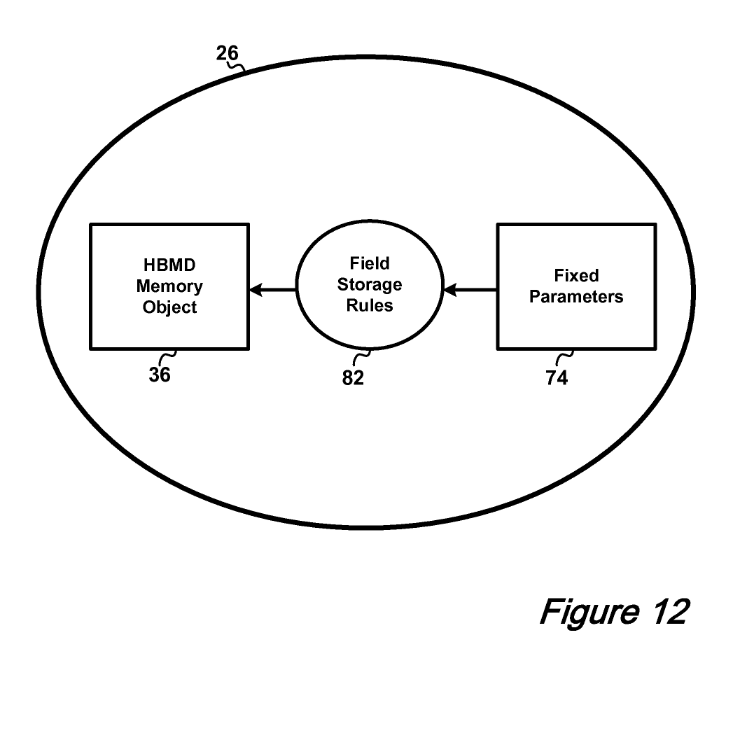

The aircraft default rules module 26, shown generally in FIG. 2 and more specifically in FIG. 12, represents a generic way to configure the logical flow of the system by enabling a mechanism that uses field storage rules 82 to store in HBMD memory object 36 product attributes from fixed parameters store 74 that are unique to each product. By way of example, the illustrative defaults listed below are specific to the JEDMICS Specification Document.

| JEDMICS | Label | Default Value in A2&3DTDP |
|---|---|---|
| 15 | Source Flavor | Blank |
| 16 | Destination Flavor | Blank |
| 19 | Site Code | 77272 |
| 23 | Media Volume ID | Blank |
| 29 | Nuclear Required | N |
| 30 | Sub-Safe? | N |

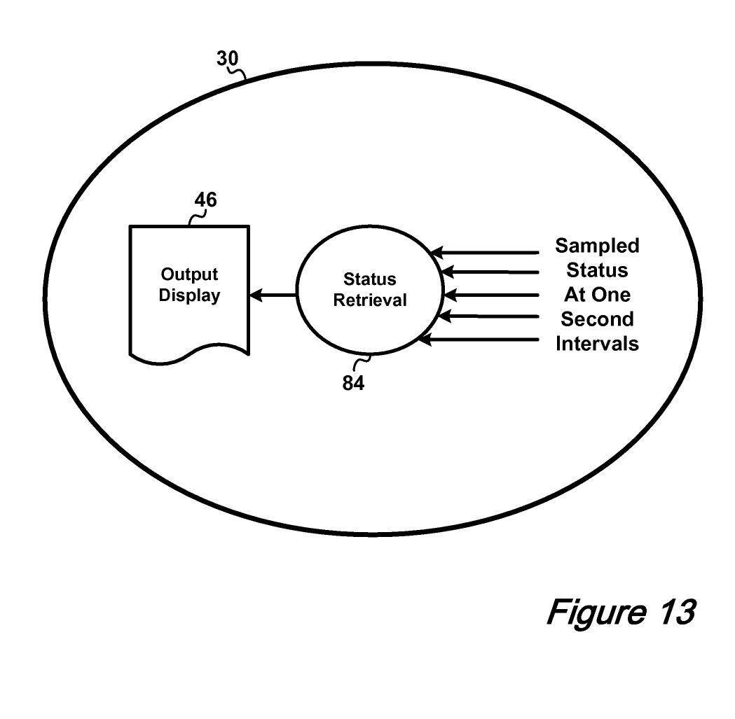

The user interface controller 30 is shown generally in FIG. 2 and specifically in FIG. 13. A status retrieval element 84 monitors the status of the other modules in the system and provides a visual summary to the input/output display 46. The status summary is performed in the way of progress bars, colors, and error reports.

The invention may be implemented in the form of a computer application which has multiple functions contained in a single toolbox/menu system. Consistent with the functionality described above, the computer application may be a Java desktop toolbox which contains the rules necessary to act on the data in a manner consistent with government expectation.

The Title, Technical Field, Background, Summary, Brief Description of the Drawings, Detailed Description, and Abstract are meant to illustrate the preferred embodiments of the invention and are not in any way intended to limit the scope of the invention. The scope of the invention is solely defined and limited in the claims set forth below.

1. An apparatus that computerizes the production of a three dimensional technical data package, comprising:
a computer software module that receives and stores one or more customer defined data submittal rules for formatting a technical data package and executes the one or more rules to create a linked set of output data files that comprises the three dimensional technical data package.

2. The apparatus of claim 1, in which the technical data package comprises one or more drawings, one or more three dimensional geometric components, part specification images, and bill of materials definitions.

3. The apparatus of claim 1, in which the technical data package comprises engineering product definitions in both two dimensional and three dimensional formats.

4. The apparatus of claim 3, in which the engineering product definitions comprise one or more of computer aided design drawings, three dimensional geometric representation, parts lists, specifications, and supplier data.

5. The apparatus of claim 1, in which the technical data package is formatted in accordance with a government promulgated specification to be followed by contractors in providing one or both of products and services to the government.

6. The apparatus of claim 5, in which the government promulgated specification is the JEDMICS specification.

7. The apparatus of claim 6, in which the JEDMICS specification is the JEDMICS specification used by NAVAIR, Lakehurst, N.J., Rev M Oct. 17, 2002.

8. The apparatus of claim 6, in which the technical data package comprises a data logistics file (DLF).

9. The apparatus of claim 1, further comprising:
an interface connected to a product data management system that receives selected product data from the product data management system.

10. The apparatus of claim 9, further comprising:
a bill of materials software module responsive to the interface and a source of parts files that (1) creates a hierarchical product data tree structure comprising one or more nodes and one or more product attribute data fields for each node and (2) links parts files together in accordance with the product data tree structure.

11. The apparatus of claim 10, in which the bill of materials software module is adapted to provide editing of the product tree structure and one of more of the product attribute data fields.

12. The apparatus of claim 10, in which the product tree structure represents an indentured bill of materials.

13. A computerized method of producing a three dimensional technical data package, comprising the steps of:
receiving and storing one or more customer defined data submittal rules for formatting a technical data package; and
executing the one or more rules to create a linked set of output data files that comprises the three dimensional technical data package.

14. The method of claim 13, further comprising the steps of:
structuring product data imported from a computer based spread sheet;
adding product attribute data to the structured product data;
editing the product attribute data; and
establishing one or more links between the structured product data, the product attributes, and external part files.

15. The method of claim 13, in which the technical data package is formatted in accordance with a government promulgated specification to be followed by contractors in providing one or both of products and services to the government.

16. The method of claim 15, in which the government promulgated specification is the JEDMICS specification.

17. The method of claim 16, in which the JEDMICS specification is the JEDMICS specification used by NAVAIR, Lakehurst, N.J., Rev M Oct. 17, 2002.

18. The method of claim 16, further comprising the step of:
computerized creation of a data logistics file (DLF).

19. The method of claim 13, further comprising the step of:
computerized error checking of the technical data package.

20. The method of claim 13, further comprising the step of:
computerized compression of the technical data package into a ZIP file.

21. The method of claim 13, further comprising the step of:
electronically sending the technical data package to a customer.

22. The method of claim 13, further comprising the steps of:
generating in a computer a hierarchical product data tree structure comprising one or more nodes and one or more product attribute data fields for each node; and
linking electronic parts files together in accordance with the product data tree structure.
